(19) United States
(12) Patent Application Publication
(10) Pub. No.: US 2016/0148276 A1
(43) Pub. Date: May 26, 2016

(54) Selecting Bids for Online Advertising Space Auction

(71) Applicant: AppNexus, Inc., New York, NY (US)

(72) Inventors: Charles Brian O'Kelley, New York, NY (US); Abel Punnittethu Mathew, New York, NY (US); Catherine Mary Williams, New York, NY (US); Fanlong Zeng, Jersey City, NJ (US); Brian George Wu, Brooklyn, NY (US); Abraham Marc Greenstein, New York, NY (US); Stephanie Chang Tzeng, New York, NY (US); Yaron Lissack, Great Neck, NY (US); Alex Mao Zhang, Brooklyn, NY (US)

(21) Appl. No.: 14/554,976

(22) Filed: Nov. 26, 2014

(51) Int. Cl. G06Q 30/02

(52) U.S. Cl. CPC G06Q 30/0275; G06Q 30/0243

(57) ABSTRACT

Methods, systems, and apparatus, including computer programs encoded on a computer storage medium, for identifying an auction element comprising one or more placement groups, ranking a plurality of advertising elements that each advertising element comprises an advertiser, one or more user target areas, one or more campaigns, and one or more creative elements, submitting top-ranked advertising elements for selection in auctions for the auction element, selecting, from the submitted top-ranked advertising elements, one or more advertising elements each having at least one success event for a specified number of impressions from the auctions for the auction element, and generating delivery allocation for the creative elements of the selected advertising elements.

### BACKGROUND

This specification relates to advertising and, in particular, selecting bids for auctions of online advertising spaces.

Online display advertising delivers promotional messages to consumers by using visual advertisements (or “ads”) in web pages. A publisher of a web page can insert an ad space in the web page. When the web page is displayed in a browser, a visual advertisement (a “creative”) of an advertiser can be dynamically retrieved from an ad server for the advertiser, and displayed in the ad space. The act of displaying or serving a creative on a web page is often referred to as an impression.

An ad inventory is a collection of one or more ad spaces on web pages served by a publisher's web sites. Publisher can sell their ad inventories to advertisers. Multiple publishers and multiple advertisers can participate in auctions in which selling and buying of ad inventories take place. Auctions can be conducted by an ad network or ad exchange that brokers between a group of publishers and a group of advertisers.

Selling and buying ad spaces can be based on pricing or payment models such as cost per thousand impressions (CPM), cost per click (CPC), and cost per action or acquisition (CPA). In the CPM model, advertisers typically pay for every 1000 (“mille”) impressions of their advertisement served. In the CPC model, advertisers typically pay each time a viewer clicks on their advertisement. In the CPA model, advertisers pay for every action, such as a sale or registration, completed as a result of a viewer clicking on their advertisement.

### SUMMARY

In general, one aspect of the subject matter described in this specification can be embodied in methods that include the actions of identifying an auction element, the auction element comprising one or more placement groups; ranking a plurality of advertising elements , each of the plurality of advertising elements comprising an advertiser, one or more user target areas, one or more campaigns, and one or more creative elements; submitting top-ranked advertising elements for selection in one or more auctions for the auction element; selecting, from the submitted top-ranked advertising elements, one or more advertising elements each having at least one success event for a specified number of impressions from the auctions for the auction element; and generating delivery allocation for the creative elements of the selected advertising elements. Identifying, ranking, submitting, selecting, and generating can be performed by one or more computer processors. Other embodiments of this aspect include corresponding systems, apparatus, and computer programs.

These and other aspects can optionally include one or more of the following features. The particular placement group can comprise one or more ad tags on web pages. Ranking the plurality of advertising element can be based on the respective advertisers of the plurality of advertising elements. A particular success event can be at least a click event or click-through event. The aspect can further comprise mapping creative elements of a particular advertising element to a list of creative size groups and mapping the target areas of the particular advertising element to one or more country groups. Each country group can comprise one or more countries. Selecting, from the submitted top-ranked advertising elements, one or more advertising elements can further comprise selecting a particular advertising element having one or more success events within a specified number of impressions from the auctions for the auction element, and for a particular creative size group and a particular country group. Generating delivery allocation for the creative elements of the selected advertising elements can comprise, for a particular selected advertising element, assigning equal weights to a set of creative elements of the particular selected advertising element, and adjusting the weights based on expected revenue generated by the set of creative elements for the selected advertising element. The adjusted weights can represent respective delivery allocation for the set of creative elements to ad spaces of the auction element. The expected revenue can be measured at least by a number of expected success events of the set of creative elements for the selected advertising element

Particular implementations of the subject matter described in this specification can be implemented to realize one or more of the following advantages. The system described herein identifies an auction element comprising one or more placement groups. Each placement group includes ad spaces on web pages. The system ranks a plurality of advertising elements that each advertising element comprises an advertiser, one or more user target areas, one or more campaigns, and one or more creative elements. The system submits top-ranked advertising elements to bid on one or more auctions for the auction element. The system selects, from the submitted top-ranked advertising elements, one or more advertising elements each having at least one success event for a specified number of impressions from the auctions for the auction element. The selected advertising elements may continue to bid on ad spaces of the auction element. The system generates delivery allocation for the creative elements of a selected advertising element to maximize expected revenue generated by the creative elements from the auction element.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for selecting bids for an ad inventory auction.

FIG. 2 is an example data flow diagram of a system for selecting bids for an ad inventory auction.

FIG. 3 is a flow chart of an example method for selecting bids for an ad inventory auction.

### DETAILED DESCRIPTION

A success event from an impression can be a click event or click-through event (e.g., an action after a click event). Other success events are possible. For a given number of impressions, it is desirable to have a higher number (thus higher rate) of success events. For a buyer of ad inventories, a higher rate of success events may indicate higher likelihood that the buyer's own web content (e.g., a landing page for a click event) will be consumed by viewers of the impressions, or actions desired by the seller will be taken by viewers of the impressions. For a seller of ad inventories, a higher rate of success events may yield higher revenue per impression (RPM) since the seller can be paid by the number of clicks or actions (e.g., paid by buyers of the ad inventories). To optimize auctions of an ad inventory, it is thus desirable to select bids that can maximize the rate of success events from impressions on the ad inventory. Particular implementations of the subject matter describe methods for selecting bids for an ad inventory auction that can maximize the rate of success events from impressions on the ad inventory. The methods test a set of bids on auctions of the ad inventory for a short period of time (a “quick test”), and select a subset of bids that have sufficient success against the ad inventory. The selected bids then can continue (or be given greater opportunities) to bid on the ad inventory for the remaining time when the ad inventory is available. Bids that are not selected (i.e., failed the quick test) may not proceed to bid on the ad inventory for the remaining time. The methods also adjust delivery allocation among creatives of a selected bid to maximize expected revenue generated by the creatives from impressions on the ad inventory.

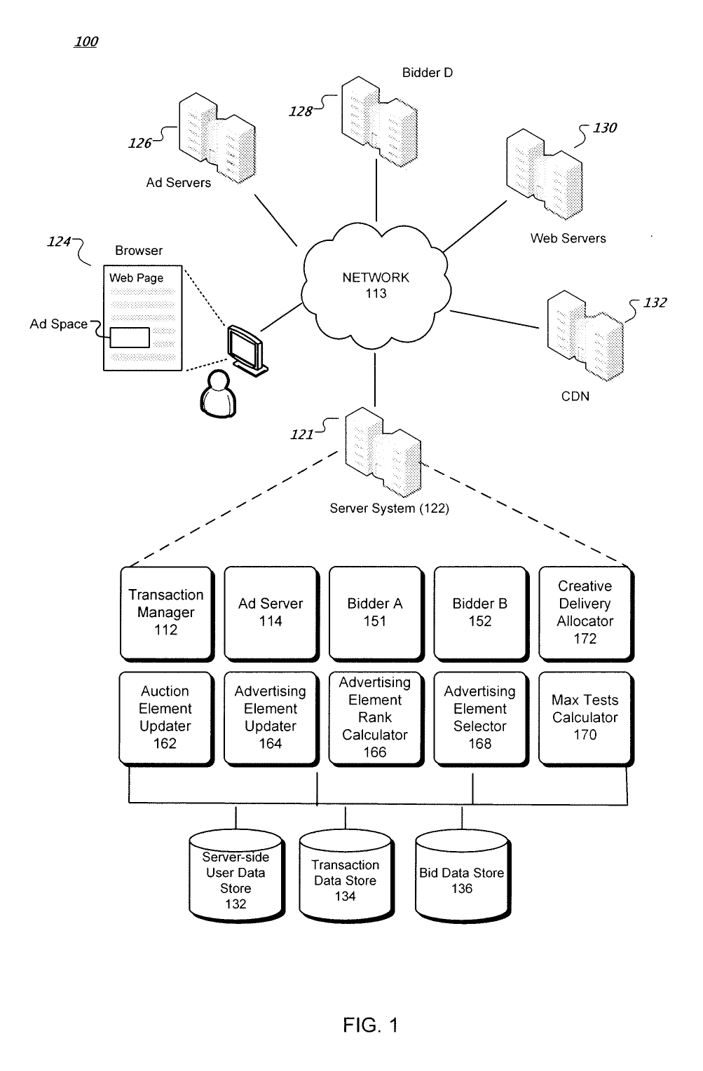

FIG. 1 illustrates an example system for selecting bids for an ad inventory auction. A server system 122 provides functionality for selecting bids for an ad inventory auction. The server system 122 comprises software components and databases that can be deployed at one or more data centers 121 in one or more geographic locations, for example. The server system 122 software components comprise a transaction manager 112, ad server 114, and one or more bidders (e.g., bidder A 151 and bidder B 152). The server system 122 software components also comprise an auction element updater 162, advertising element updater 164, advertising element rank calculator 166, advertising element selector 168, max tests calculator 170, and creative delivery allocator 172. The server system 122 can also include one or more software components for load balancing tools and security tools. The load balancing tools manage traffic within a single data center or between multiple data centers. The security tools manage data protection and access privilege for tenants served by the data centers 121. The software components can comprise subcomponents that can execute on the same or on different individual data processing apparatus. The server system 122 databases comprise a server-side user data store database 102, transaction data store database 134, and bid data store database 136. The databases can reside in one or more physical storage systems. The software components and data will be further described below.

The transaction manager 112 (“impression bus” or simply “Imp Bus”) is a software component that facilitates the transaction aspects of ad inventory trading between buyers and sellers. A buyer can be an advertiser (e.g., Visa Inc., Adidas AG), an ad network (e.g., DoubleClick of Google, Inc., Bing Ads of Microsoft Corporation), or an advertising agency (e.g., OMG National). Other buyers are possible. A seller can be a publisher (e.g., The Washington Post, CNBC, Facebook), an online streaming or gaming service (e.g., Hulu, Xbox Live of Microsoft Corporation), or an ad network. Other sellers are possible. The transaction manager 112 processes ad requests, feeds data to advertisers, conducts auctions (e.g., on behalf of sellers), returns creative to the publishers, keeps track of billing and usage, returns auction-result data, and enforces quality standards, for example. The transaction manager 112 stores in the transaction data store database 134 various transaction information for each and every ad space that is transacted by the transaction manager 112 or other software components of the server system 122. /

The ad server 114 is a software component that serves ads or creatives to web pages. The ad server 114 can also make decisions about what ads to be served, track clicks on ads and other data, for example. A bidder (e.g., bidder A 151, bidder B 152) is a software component that, on behalf of a buyer, performs bidding operations. The bidder takes various pieces of bid-specific information (e.g., maximal bid price, target user areas or segments, start and end dates, budget) as input and generates a bid for a particular item of an ad inventory, for example. The bidder may store bid-specific information in bid data store database 136. The transaction manager 112 can conduct an auction when receiving an ad request.

By way of illustration, a web page of a publisher can include an ad tag for an ad space on the web page. The ad tag includes a URL (e.g., URL for the server system 122) from which an ad will be requested, and HTML or JavaScript codes for instructing a browser how to display the ad (e.g., displaying the ad in a 160×600 iframe). A browser 124 running on a user's client device (e.g., a desktop or laptop computer, a tablet computer, a mobile phone, a game console, an in-car media system) can retrieve the web page through one or more data communication networks 113 such as the Internet, for example, from web servers 130 of the publisher. The ad tag causes the browser to send (e.g., through the networks 113) an ad request to the server system 122. The ad request can include information about the ad space (e.g., a size for the ad space, an identifier for the publisher), user information (e.g., an identifier of the user, an IP address), and system information (e.g., types of the browser and the client device), for example.

In response to the ad request, the transaction manager 112 can access a server-side user data store database 132 based on the user's identifier (if available), and retrieve available information about the user (e.g., user segment information such as age, gender, interests, or location). The transaction manager 112 generates a bid request including information about the ad space, the user, and so on, and sends the bid request to multiple bidders such as bidder A 151 and bidder B 152. The transaction manager 112 can also send the bid request through the networks 113 to servers of bidder D 128, which is external to the server system 122.

Each bidder can base on its own requirement (e.g., budget, targets in placements or user demographics) and submits a bid response including a bid price and an identifier of a creative to be served, for example, to the transaction manager 112 (or not to respond at all). The transaction manager 112 determines a winning bid (e.g., a highest bid) among bid responses received within a specified time period (e.g., 10 milliseconds). The transaction manager 112 then returns a URL for a creative of the winning bid to the user's client device, causing the browser to retrieve the creative from an ad server (e.g., ad server 114, or ad servers 126 external to the server system 122), or from servers of a content distribution network (CDN) 132.

The auction element updater 162 is a software component that identifies an auction element for an auction. An auction element can be an ad inventory from a seller,—i.e., a collection of ad spaces on web pages served by the seller's web sites. More particularly, an auction element (“optimization zone” or simply “ozone”) comprises one or more placement groups. Each placement group includes one or more ad tags (i.e., ad spaces) on web pages served by the seller's web sites. Here, the seller can group a set of web pages (identified by the ad tags) by its liking for an auction, as the seller may have the best understanding of web pages on its web properties. For instance, the seller can group a particular set of web pages related to basketball for an auction. This particular set of web pages can offer a better targeting of impression viewers who are interested in basketball or sports (e.g., for an advertiser of sporting goods), and potentially has higher success rate from impressions on this particular set of web pages. In some implementations, a placement group may correspond to web pages of one or more particular websites (e.g., websites covering scores and news of basketball games).

The seller can submit an auction element to the transaction manager 112 (or another software component of the server system 122) via an auction element application programming interface or API (e.g., api. ozone), causing the transaction manager 112 to store the auction element in the bid data store database 136, for example. The auction element updater 162 can identify an auction element by listening to the auction element API api. ozone for a new auction element. In some implementations, the auction element updater 162 periodically (e.g., every hour, or every 6 hours) checks the bid data store database 136 for new auction elements.

The advertising element updater 164 is a software component that identifies a plurality of advertising elements that will bid on an auction element. An advertising element or line item includes one or more advertising campaigns for an advertiser (a buyer). A line item can be a financial agreement with an advertiser that includes effective start and end dates (“flight dates”) and a budget (e.g., lifetime budget, daily budget). A line item can also include performance goals (e.g., based on CPC or CPA payment model) that can be used to determine whether or not to bid on an ad inventory. A line item can also include one or more conversion pixels that are used to track revenue or performance goals. A line item can also include targets such as devices (e.g., desktop and laptop computer, tablet computer, mobile phone), placements (e.g., desktop and laptop web page, mobile web page, mobile application), domains (e.g., web domains, mobile applications, websites), user geographic areas, or user systems (e.g., carriers, operating systems, browsers, devices). Other line item targets are possible. A line item can also include on or more creatives.

Each advertising campaign of a line item includes a set of creatives that promote an idea, theme, product, or brand (e.g., a children's brand, a healthy lifestyle, a new car model). Similarly to a line item, an advertising campaign can include flight dates and a budget. An advertising campaign also includes one or more payment types (e.g., CPC, CPM, CPA) and bidding instructions (e.g., a bid price) on ad inventories, and one or more creatives. An advertising campaign can also include targets in devices, placements, domains, user geographic areas, user systems. An advertising campaign can have more granular controls in targeting than a line item, such as targets in inventory segments (e.g., automobiles, home and garden, sports), publishers, and user segments (e.g., demographics). Other advertising campaign targets are possible.

In some implementations, a line item may have precedence over its advertising campaigns. For instance, an advertising campaign cannot bid after its parent line item's flight dates had expired. In some other implementations, an advertising campaign may have precedence over its parent line item. For instance, if an advertising campaign's user target geographic area is smaller than but is part of the user target geographic area of its parent line item, the advertising campaign will bid only within its own user target geographic area. In yet some other implementations, an aggregation of targets or creatives of a line item and its advertising campaigns can be used to bid on an auction element or ad inventory. A buyer (e.g., an advertiser or an ad network) can submit a line item including one or more advertising campaigns to a bidder (e.g., bidder A 151) through a line item API (e.g., bidder. campaign_{—} group), causing the bidder to store the line item in the bid data store database 136. The advertising element updater 164 can identify new line items by listening to the line item API bidder. campaign_{—} group. In some implementations, the advertising element updater 164 can periodically (e.g., every 30 minutes, every 4 hours) check the bid data store database 136 for new line items.

For each new line item identified, the advertising element updater 164 maps creatives of the line item (e.g., creatives of the advertising campaigns of the line item) to a list of creative size groups. Mapping to the (pre-determined) list of creative size groups (instead of considering all creative sizes of all creatives of the line item) can reduce the computing time needed to find out the best line items for the auction element as a less number of permutation may need to be considered. The advertising element updater 164 can store the mapping of creative size groups of the line item in the bid data store database 136.

By way of illustration, the list of creative size groups can include the 10 most common creative sizes (in pixels) processed by the transaction manager 112 over a period of time (e.g., past 6 months), as shown in the table below.

| Width | Height |
|---|---|
| 300 | 250 |
| 728 | 90 |
| 160 | 600 |
| 120 | 600 |
| 468 | 60 |
| 300 | 600 |
| 320 | 50 |
| 200 | 200 |
| 336 | 280 |
| 99 | 72 |

A creative of the line item can be mapped to a particular creative size group (“bucket”) listed in the table above. A creative of the line item can be mapped to a particular creative size bucket if the creative's width and height match those of the particular creative size bucket. For instance, a creative with a size of (120, 600) can be mapped to the (120, 600) creative size bucket. In some implementations, a creative of the line item can be mapped to a particular creative size bucket if the aspect ratios (e.g., width vs. height) match and the area difference is within a pre-determined percentage (e.g., 10 percent). For instance, a creative with a size of (185, 185) can be mapped to the (200, 200) creative size bucket. All the creatives of the line item that are not matched to one of the creative sizes in the table above can be mapped to a pre-set creative size group—e.g., (−1, −1).

For each new line item identified, the advertising element updater 164 maps target user geographic areas of a line item (e.g., target user geographic areas of the advertising campaigns of the line item) to a list of country groups. A country group can include one country that has a large online advertising market. A country group can include multiple countries that each has a small online advertising market but together have a large aggregated online advertising market. In this way, each country group represents a large online advertising market. For instance, for Western Europe, United Kingdom, Germany, and France can each correspond to a country group. Another country group for the rest of Western Europe can include Ireland, Netherlands, Belgium, Luxembourg, Switzerland, Spain, Portugal, Italy, ad Austria. Mapping to the (pre-determined) list of country groups (instead of considering all detailed target areas of the line item) can reduce the computing time needed to find out the best line items for the auction element as a less number of permiutation may need to be considered.

For instance, a line item for BMW (Bayerische Motoren Werke AG) can include two advertising campaigns for a new BMW car model (e.g., a new 5-Series). One advertising campaign targets users in United States, and another advertising campaign targets users in Germany, France, Belgium, Netherlands, Luxembourg, Switzerland, and Austria. In this example, the advertising element updater 164 can map the line item's target user geographic areas to a country group corresponding to the United States, a country group corresponding to Germany, a country group corresponding to France, and a country group corresponding to the rest of Western Europe covering the target areas Belgium, Netherlands, Luxembourg, Switzerland, and Austria.

The advertising element updater 164 can map target areas of a line item (LI) to a list of country groups (CG), for example, [CG1, CG2, CG3, CG4 . . .]. The advertising element updater 164 can map a country group to a list of line items, for example, [LI1, LI2, LI3, LI4 . . . ]. The advertising element updater 164 can store the mapping between line items and country groups in the bid data store database 136.

Data for the line items obtained by the advertising element updater 164 can be stored in the bid data store database 136 using an associate array data structure with key-value pairs (“optimization entities”). Each key of a key-value pair can be a combination of one or more parameters including auction element or optimization zone (OZ), country group (CG), creative size group (SZ), line item (LI), and aggregation level (AL). Other parameters in a key are possible. The aggregation level can represent a higher (bigger) level of entities such as advertisers or brands. When a new line item or an auction element are obtained (by the advertising element updater 164 or auction element updater 162, respectively), the auction element updater 162 or another software component of the server system 122 can create keys that each includes a combination of auction element, country group, creative size group, aggregation level, and line item (oz:CG:SZ:AL:LI), and store key-value pairs for these keys in the bid data store database 136. For instance, an oz:CG:SZ:AL:LI key can be ad_inventory_from_LATimes :US:160×600:BMW:BMW_5_Series, which can represent a key for the line item including BMW 5-Series advertising campaigns for advertiser BMW as described earlier, creative size bucket (160,600), country group US, and an ad inventory from publisher LA Times. The value of an oz:CG:SZ:AL:LI key can be a list of values including, for example, a number of impressions, a number of clicks, and a number of actions (with all values initialized to zeroes). Other values in the key-value pairs are possible.

The advertising element rank calculator 166 is a software component that ranks the advertising elements or line items obtained by the advertising element updater 164. The advertising element rank calculator 166 can rank the line items based on the rank of the advertisers (or brands) of the line items. For instance, the advertising element rank calculator 166 can access the transaction data store database 134 for transaction data related to the advertisers. The advertising element rank calculator 166 can rank the advertisers based on each advertiser's past performance (e.g., revenue per thousand impressions) overall, or on the auction element obtained by the auction element updater 162. The advertising element rank calculator 166 then ranks the line items according to the ranking of the respective advertisers of the line items. The advertising element rank calculator 166 can also rank the line items based on each line item's past performance on different geographical areas or country groups.

The advertising element selector 168 is a software component that selects from top-ranked line items (as ranked by the advertising element rank calculator 166), one or more line items that each has sufficient success when tested against the auction element obtained by the auction element updater 162 (the quick test). That is, the advertising element selector 168 submits each top-ranked line item to bid on auctions of the ad inventory of the auction element (when one or more of the ad spaces of the ad inventory become available and accepting bids), and determines whether the line item has sufficient success from bidding on the auctions.

A top-ranked line item is selected if the line item has sufficient success when bidding on auctions conducted on the ad inventory of the auction element, for example, when the line item has at least one success event for the auction element. For instance, a line item is selected (i.e., passes the quick test against the auction element) if the line item has at least one success event (e.g., a click even, or a click-through event) from a pre-determined number of impressions (e.g., 10,000 impressions) generated from the auctions. A line item is not selected (i.e., fails the quick test against the auction element) when the line item has no success event from the pre-determined number of impressions. A line item is not selected if a pre-determined time period (e.g., 30 minutes) has elapsed and no impression has been generated from the auctions. A line item is not selected if the pre-determined time period has elapsed and less than a pre-determined number of impressions (e.g., 500) has been generated from the auctions (i.e., low impression generation rate), and no success event is generated from these impressions. Selected line items then continue to bid on ad spaces of the auction element for the remaining time when the auction element is available. Line items that fail the quick test against the auction element are not selected and may not proceed to bid on ad spaces of the auction element for the remaining time, as these line items are unlikely to generate significant impressions or success events.

The advertising element selector 168 can test and select line items by stepping through combinations of auction element, country group, creative size bucket, and line item. That is, the advertising element selector 169 can test and select line items by stepping through possible oz:CG:SZ:LI keys. For each combination of a particular auction element, particular country group, and particular creative size bucket (oz:CG:sz), the advertising element selector 169 submits available line items (with one or more creatives in the particular creative size bucket, and with one or more user target geographic area within the particular country group), to test against the particular auction element, and selects one or more line items that each has at least one success event for the particular auction element.

It is desirable to limit the number of top-ranked line items to be tested against the auction element (thus limiting total elapsed time for the tests) for a timely decision on selecting line items for the auction element. Meanwhile, it is desirable that a line item is tested against the auction element in a sufficiently slow pace such that the line item can be tested at different times during a day. The max tests calculator 170 is a software component that determines a number of top-ranked line items to be tested against the auction element (by the advertising element selector 168). The max test calculator 170 can determines a number of top-ranked line items to be tested based on the number of days available to test the top-ranked items by the advertising element selector 168, the number of impressions available for testing the top-ranked line items per day, and the number of impressions needed for testing a line item. For instance, the max tests calculator 170 can determines the number of top-ranked line items to be tested, by the relationship as follows:

Number of days to test top-ranked line items (D)=Number of impressions needed for testing a line item (N)×Number of top-ranked line items to be tested (X)/Number of impressions available for testing top-ranked line items per day (V),

or

X=D×V/N.

The number of top-ranked line items to be tested can be determined for each particular auction element and country group combinations (e.g., OZ1:CG1, OZ1:CG2, OZ1:CG3 . . . OZ2:CG1, OZ2:CG2, OZ2:CG2 . . . ).

For a selected line item (i.e., having sufficient success when tested against the auction element), the probability of a creative of the selected line item that is going to be delivered (served) to ad spaces of the auction element going forward can be allocated to optimize the overall expected revenue generated by the creative of the line item from the auction element (over the remaining time when the auction element is available). The creative delivery allocator 172 is a software component that generates delivery allocation for the creative of a selected line item. The creative delivery allocator 172 generates delivery allocation by randomly selecting among the creatives at auction time, first assigning equal weights to the creatives for the random selection process, then adjusting the weights based on expected revenue generated by the creatives from the auction element.

For example, for a particular combination of line item, country group, and creative size bucket (a particular LI:CG:SZ key), the creative delivery allocator 172 can first assign equal weights to the line item's creatives that are mapped to the particular creative size bucket, then adjust the weights in multiple time steps. Similar to solving a multi-amied bandit problem, the creative delivery allocator 172 can assign, at each time step, more weight to a particular creative that has the highest expected revenue from the line item. For instance, assume here that expected revenue can be measured by a number of expected success events multiplied by a payment value per success event from the line item. At a time step (t−1), the creative delivery allocator 172 can identify a particular creative that has the most success events for the line item by the time step (t−1), and then apply more weight to the particular creative at the next time step t, as the particular creative is expected to have most success events at the next time step t based on its past performance till the time step (t−1).

By way of illustration, let T denote the time index of a weight-updating stochastic process, in which T=t (t=1, 2, 3 . . . ). Let a particular combination of line item, country group, and creative size bucket (a particular LI:CG:sz key) have k creatives. Let 0, denotes the conversion rate variables at time t for these k creatives:

θₜ=(θₜ₁, θₜ₂, . . . , θᵢₖ)

Let that the conversion rate (i.e., rate of success events) for each of these creatives follow beta distribution, and marginal distribution for each variable can be as follows:

θₜᵢ˜beta(αₜᵢ, βₜᵢ) for i=1, 2, . . . , k.

When T moves along to t, αₜᵢ and βₜᵢ are adjusted for i=1, 2, . . . , k, based on α₍ₜ₋₁₎ᵢ and β₍ₜ₋₁₎ᵢ, and the data collected between time (t−1) and t. Here, the stochastic process can constitute a Markov chain since the current state only depends on the last state. For instance, for creative i, Nₜᵢ impressions and Yₜᵢ conversions between time (t−1) and t are collected. Then these parameters are updated as follows:

αₜᵢ=α₍ₜ₋₁₎ᵢ+Yₜᵢ

βₜᵢ=β₍ₜ₋₁₎ᵢ+(Nₜᵢ−Yₜᵢ)

After these parameters are updated, the optimal probabilities are computed. Weights are assigned in proportional of the optimal probabilities. Let πₜ denote the optimal probability distribution at time t for all k creatives:

$${π}_{t} = ( {π}_{t 1} , {π}_{t 2} , … , {π}_{tk} ) , where {\sum }_{i = 1}^{k} {π}_{ti} = 1.$$

The weights can be calculated using αₜᵢ and βₜᵢ with the following integral:

πₜᵢ=∫Iᵢ(θᵢ)*P(θₜ|Nₜ, Yₜ)dθₜ

The domain of integration of the above integral is from 0 to 1 for each dimension of the variable of integration. Note that the posterior distribution is a joint distribution on O. Here, Montel Carlo simulation can be used to approximately compute the weights assuming mutual independence among θₜᵢ and θₜⱼ for any 1≦i,j≦k.

By way of illustration, for all the k creatives, the conversion rates are initialized with Jeffrey's prior distribution, while the α and β parameters are initialized as follows:

α=0.5; β=0.5.

Let the optimal probabilities or weights for all k creatives existing at the time (t−1), for particular combination of line item, country group, and creative size bucket (a particular LI:CG:sz key), are:

wₜ₋₁=(w₍ₜ₌₁₎₁, w₍ₜ₋₁₎₂, . . . , w₍ₜ₋₁₎ₖ).

For every new creative (k+1) added between the time (t−1) and t, the weights can be updated as follows:

$${\overline{w}}_{t - 1} = ( {w}_{( t - 1 ) 1} * \frac{k}{k + 1} , {w}_{( t - 1 ) 2} * \frac{k}{k + 1} , … , {w}_{( t - 1 ) k} * \frac{k}{k + 1} , \frac{1}{k + 1} ) .$$

Let l denotes the number of new creatives added between the time (t−1) and t. Based on the conversion data collected between the time (t−1) and t, new weights w̅ₜ can be computed using Monte Carlo simulation as described earlier:

w̅ₜ=(wₜ₁, wₜ₂, . . . , wₖ₍ₜ₋₁₎)

Lower performing creatives can be filtered out (i.e., not to be served to web pages of the auction element going forward) by using a pre-determined threshold. For instance, a creative can be filtered out if its corresponding weight is less than 0.01 (one percent):

wₜᵢ≦0.01.

By way of illustration, if l creatives are added and m creatives are filtered out at the time t, for the next time period between time t and (t+1), the (k+l−m) remaining creatives are served to web pages of the auction element using the weights distribution as follows:

$${w}_{t} = ( \frac{{w}_{t 1}}{w} , \frac{{w}_{t 2}}{w} , \frac{{w}_{( k + l - m )}}{w} , 0 , … , 0 ) , where w = {\sum }_{i = 1}^{k + l - m} {w}_{ti} .$$

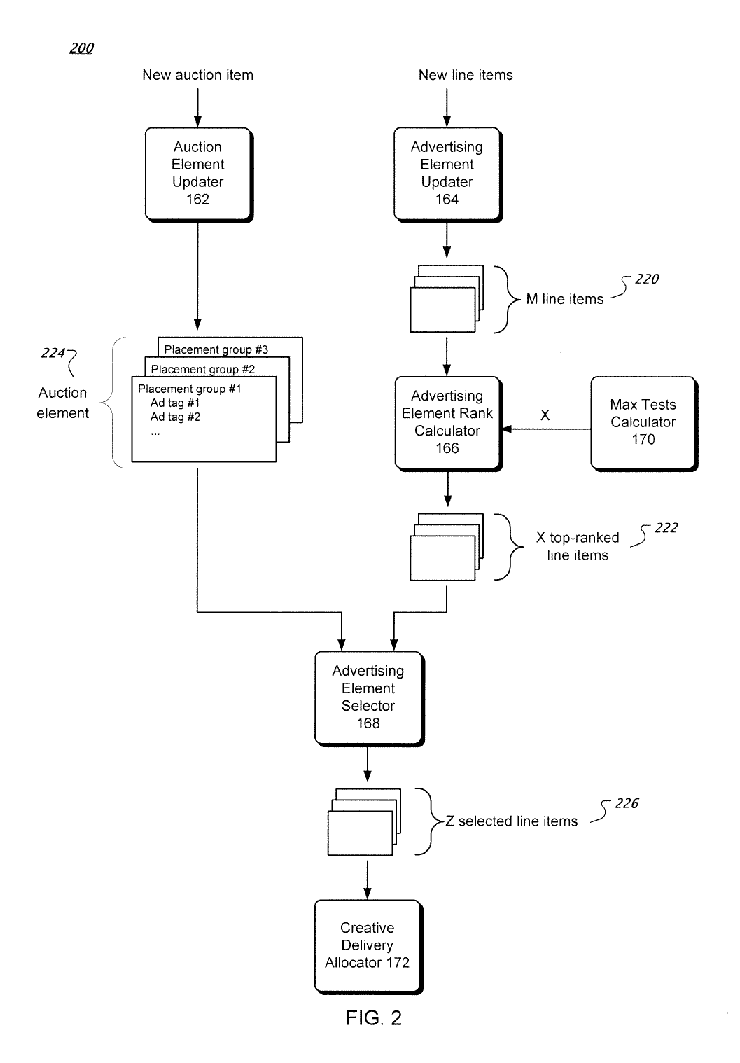

FIG. 2 is an example data flow diagram of the system illustrated in FIG. 1. The auction element updater 162 obtains a new auction element including one or more placement groups. Each placement group includes one or more ad tags on web pages served by a seller's web site. The advertising element updater 164 receives (e.g., from one or more buyers) new line items. Each line item includes an advertiser, one or more user target areas, one or more advertising campaigns, and one or more creatives.

The advertising element rank calculator 166 ranks line items obtained by the advertising element updater 164, and provides top-ranked line items to advertising element selector 168 for testing against the auction element. The max tests calculator 170 determines a number of top-ranked line items that are to be tested against the auction element. For instance, the advertising element rank calculator 166 may receive M line items (220) from the advertising element updater 164. The max tests calculator 170 may determines X line items (X≦M) that are to be tested against the auction element. Then the advertising element rank calculator can pass X top-ranked line items (222) to the advertising element selector 168.

The advertising element selector 168 (the quick test) then tests the top-ranked line items (222) against the auction element (224), and selects one or more line items that each has at least one success event for the auction element. For instance, the advertising element selector 168 may select Z line items (226) from the X top-ranked line items from the advertising element rank calculator 166 (Z≦X). The selected Z line items then can continue to bid on ad spaces of the auction element for the remaining time when the auction element is available. Furthermore, the selected Z line items are provided to the creative delivery allocator 172. For each selected line item, the creative delivery allocator 172 generates delivery allocation among the creatives of the selected line item to be served to ad spaces of the auction element such that the overall expected revenue generated by the creatives can be optimized (over the remaining time when the auction element is available).

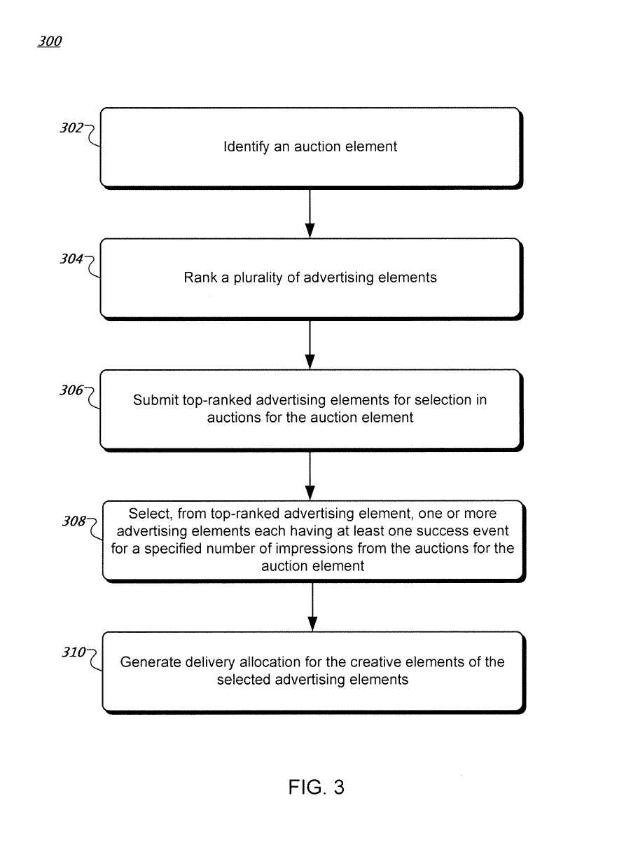

FIG. 3 is a flow chart of an example method for selecting bids for an ad inventory auction. The method can be implemented using software components executing on one or more data processing apparatus that are part of the data center 121 described earlier. The method begins by identifying an auction element (302). The auction element comprises one or more placement groups. Each placement group comprises one or more ad tags on web pages. The method ranks a plurality of advertising elements (304). Each advertising element or line item comprises an advertiser, one or more user target areas, one or more advertising campaigns, and on or more creative elements. The method submit top-ranked advertising elements to bid on one or more auctions for the auction element (306). The method selects, from the submitted top-ranked advertising elements, one or more advertising elements each having at least one success event for a specified number of impressions from the auctions for the auction element (308). A success event can be a click event, or a click-through event such as an action or an acquisition event. The method generates delivery allocation for the creative elements of the selected advertising elements (310).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
identifying an auction element, the auction element comprising one or more placement groups;
ranking a plurality of advertising elements, each of the plurality of advertising elements comprising an advertiser, one or more user target areas, one or more campaigns, and one or more creative elements;
submitting top-ranked advertising elements for selection in on one or more auctions for the auction element;
selecting, from the submitted top-ranked advertising elements, one or more advertising elements each having at least one success event for a specified number of impressions from the auctions for the auction element; and
generating delivery allocation for the creative elements of the selected advertising elements,
wherein identifying, ranking, submitting, selecting, and generating are performed by one or more computer processors.

2. The method of claim 1, wherein a particular placement group comprises one or more ad tags on web pages.

3. The method of claim 1, wherein ranking the plurality of advertising elements is based on the respective advertisers of the plurality of advertising elements.

4. The method of claim 1, wherein a particular success event is at least a click event or click-through event.

5. The method of claim 1, further comprising:
mapping creative elements of a particular advertising element to a list of creative size groups; and
mapping the target areas of the particular advertising element to one or more country groups, each country group comprising one or more countries.

6. The method of claim 5, wherein selecting, from the submitted top-ranked advertising elements, one or more advertising elements further comprises selecting a particular advertising element having one or more success events within a specified number of impressions from the auctions for the auction element, and for a particular creative size group and a particular country group.

7. The method of claim 1, wherein generating delivery allocation for the creative elements of the selected advertising elements comprising, for a particular selected advertising element:
assigning equal weights to a set of creative elements of the particular selected advertising element; and
adjusting the weights based on an expected revenue generated by the set of creative elements for the selected advertising element, the adjusted weights representing respective delivery allocation for the set of creative elements to ad spaces of the auction element.

8. The method of claim 7, wherein the expected revenue is measured at least by a number of expected success events of the set of creative elements for the selected advertising element.

9. A system comprising one or more computer processors programmed to perform operations comprising:
identifying an auction element, the auction element comprising one or more placement groups;
ranking a plurality of advertising elements, each of the plurality of advertising elements comprising an advertiser, one or more user target areas, one or more campaigns, and one or more creative elements;
submitting top-ranked advertising elements for selection in one or more auctions for the auction element;
selecting, from the submitted top-ranked advertising elements, one or more advertising elements each having at least one success event for a specified number of impressions from the auctions for the auction element; and
generating delivery allocation for the creative elements of the selected advertising elements.

10. The system of claim 9, wherein a particular placement group comprises one or more ad tags on web pages.

11. The system of claim 9, wherein ranking the plurality of advertising elements is based on the respective advertisers of the plurality of advertising elements.

12. The system of claim 9, wherein a particular success event is at least a click event or click-through event.

13. The system of claim 9, wherein the one or more computer processors are programmed to perform further operations comprising:
mapping creative elements of a particular advertising element to a list of creative size groups; and
mapping the target areas of the particular advertising element to one or more country groups, each country group comprising one or more countries.

14. The system of claim 13, wherein selecting, from the submitted top-ranked advertising elements, one or more advertising elements further comprises selecting a particular advertising element having one or more success events within a specified number of impressions from the auctions for the auction element, and for a particular creative size group and a particular country group.

15. The system of claim 9, wherein generating delivery allocation for the creative elements of the selected advertising elements comprising, for a particular selected advertising element:
assigning equal weights to a set of creative elements of the particular selected advertising element; and
adjusting the weights based on an expected revenue generated by the set of creative elements for the selected advertising element, the adjusted weights representing respective delivery allocation for the set of creative elements to ad spaces of the auction element.

16. The system of claim 15, wherein the expected revenue is measured at least by a number of expected success events of the set of creative elements for the selected advertising element.
